(19) United States
(12) Patent Application Publication
(10) Pub. No.: US 2010/0199202 A1
(43) Pub. Date: Aug. 5, 2010

(54) Selecting Channels of a Data Set for Visibility

(76) Inventor: Thomas Becker, Aachen (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 12/365,660

(22) Filed: Feb. 4, 2009

(51) Int. Cl. G06F 3/048

(52) U.S. Cl. 715/771

(57) ABSTRACT

Selecting channels of a data set for visibility. A first user input specifying a data set may be received. A plurality of channels of the data set may be displayed in a first portion of a display in response to the first user input. A second user input selecting one or more channels of the data set in the first portion of the display may be received. The second user input may specify that the first one or more channels are always visible in the first portion of the display. The one or more channels may always be visible in the first portion of the display in response to the second user input.

### FIELD OF THE INVENTION

The present invention relates generally to computer software and more particularly to a system and method for selecting channels of a data set for visibility.

### DESCRIPTION OF THE RELEVANT ART

Technical Data Management (TDM) may include a large collection of functionality and operations performed by different applications and services in handling, processing and managing technical data from measurements, from simulations, and from various other technical data processing activities. The applications and services involved in TDM are typically within the operations of an engineering or scientific enterprise, or other organizational entity. The operations may include a wide variety of workflow processes related to technical data, including:

storing and retrieving technical data

exploring, searching and filtering technical data sets

managing and maintaining technical data stores

transmitting technical data to remote users

importing and exporting technical data from foreign systems

supporting network operations for TDM.

The field of Technical Data Management (TDM) may specifically include computer-based tools for acquiring, storing, and retrieving measurement data. As used herein, measurement data may represent a type of technical data acquired by a test and measurement application, e.g., via test and measurement hardware, such as data acquisition (DAQ) hardware or other hardware. Such data may be stored as data sets and may be accessible for operations such as the abovementioned exploring, searching, and filtering of technical data sets. However, if there is a very large amount of data in a given data set, the existing methods and tools of TDM may be insufficient for efficient manipulation of data sets. Thus, improvements in the field are desirable.

### SUMMARY OF THE INVENTION

Various embodiments are presented of a system and method for selecting channels of a data set to be always visible in a display.

First user input may be received which specifies a data set, e.g., a measurement data set. The method may further include displaying a plurality of channels of the data set in a first portion of a display in response to the first user input. The first portion of the display may take the form of a hierarchical tree-structure.

Second user input may be received. The second user input may specify or select a first one or more channels of the data set. The second user input may specify that the first one or more channels are always visible in the first portion of the display. The method may further include storing information in a memory in response to the second user input. The information may indicate that the first one or more channels are always to remain visible in the first portion of the display, e.g. even if a filtering action is performed on the plurality of channels, e.g., whose result may not include the selected one or more channels.

In some embodiments, at least one graphical icon may be displayed in the first portion of the display. The at least one graphical icon may be associated with the first one or more channels. The at least one graphical icon may visually indicate that the first one or more channels are always visible in the first portion of the display.

In some embodiments, it may be possible to receive third user input specifying text for one or more text-filters. In these embodiments, a second one or more channels may be filtered from display as a result of the third user input. The second one or more channels may no longer be visible in the first portion of the display after being filtered. The first one or more channels may remain visible in the first portion of the display regardless of the one or more text-filters.

In some embodiments, user input specifying that only the first one or more channels are visible in the first portion of the display may be received. In response to this user input, only the first one or more channels may be displayed in the first portion of the display.

The plurality of channels may be divided into groups which may be visible in the first portion of the display. In these embodiments, the second user input selecting the first one or more channels may include selecting one or more groups. The second user input may include selecting a combination of channels and groups. Both the channels and the groups of channels included in the second user input may always be visible in the first portion of the display.

At least a portion of the data set may be displayed in a second portion of the display. For example, user input may specify one or more channels to be displayed in the second portion of the display. In response to this user input, data corresponding to the specified one or more channels may be displayed in the second portion of the display.

User input specifying one or more channels to no longer always be visible in the first portion of the display may be received. In response to this user input, the specified channels may no longer always be displayed in the first portion of the display.

The above-described method may be implemented in a variety of systems. For example, the method may be implemented as a computer program which may be executed by a computer system. For example, program instructions may be stored on a memory medium which may be executable by a processor to perform the method.

A further set of embodiments may include a computer system. Similarly, the method may be implemented by a computer system including a processor, a display coupled to the processor, and a memory medium coupled to the processor. In these embodiments, the memory medium may include program instructions executable by the processor to perform the methods described above. In some embodiments, the display may include at least a first portion and a second portion, and may be operable to display information according to the methods described above.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a computer system according to one embodiment;

FIG. 2 illustrates a distributed computing environment according to one embodiment;

FIG. 3 illustrates a TDM framework according to one embodiment;

FIGS. 4A and 4B illustrate a hierarchical data model in one embodiment;

FIG. 5 is a flowchart diagram illustrating one embodiment of a method for selecting channels of a data set to always be visible in a display; and

FIG. 6-11B are exemplary screenshots illustrating the method of FIG. 5 and related embodiments.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### INCORPORATION BY REFERENCE

The following references are hereby incorporated by reference in their entirety as though fully and completely set forth herein:

U.S. Patent Publication No. 2007/0038592 A1 (Ser. No. 11/461,627) titled “Method for Indexing File Structures in an Enterprise Data System,” filed Aug. 1, 2006, whose inventors are Andreas Peter Haub, Stefan Romainczyk, Ralf Deininger and Helmut J. Helpenstein, Andreas Krantz and Myrle Krantz; and U.S. Pat. No. 4,914,568 titled “Graphical System for Modeling a Process and Associated Method,” issued on Apr. 3, 1990.

### Terms:

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

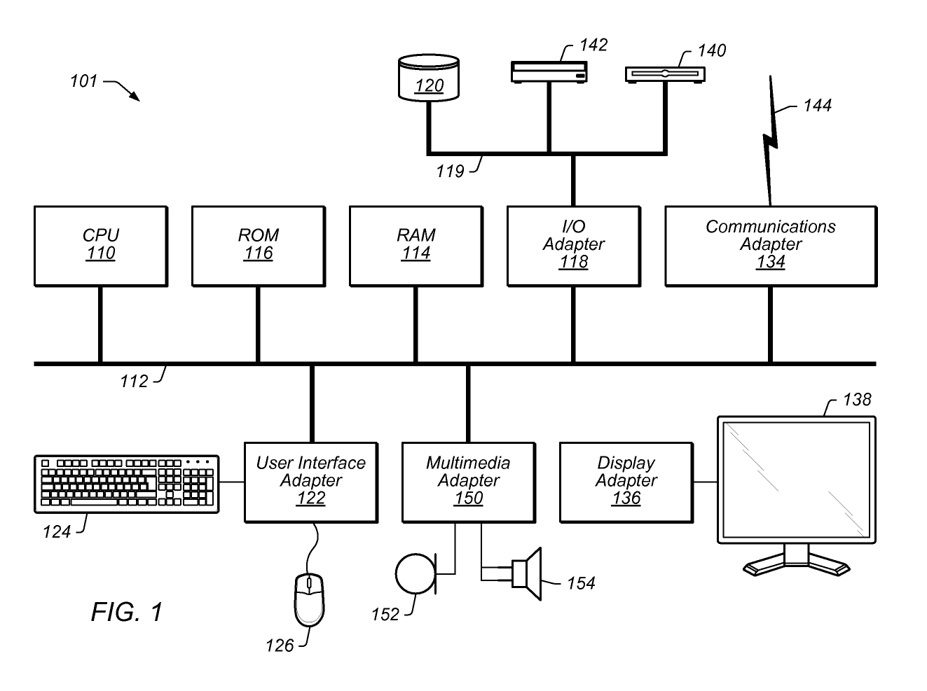

### FIG. 1—Exemplary Computer System

A representative hardware platform for practicing the methods described herein is depicted in FIG. 1, which illustrates an exemplary hardware configuration of a computer system 101. The computer system 101 may execute computer programs which may be stored on volatile or non-volatile memory. In various embodiments, the computer system 101 may comprise a desktop computer, a laptop computer, a palmtop computer, a network computer, a personal digital assistant (PDA), an embedded device, a smart phone, or any other suitable computing device.

The computer system 101 includes at least one central processing unit (CPU) or other processor(s) 110, such as a conventional microprocessor, and a number of other units interconnected via system bus 112. The CPU 110 may include other circuitry not shown herein, such as circuitry commonly found within a microprocessor, e.g., execution unit, bus interface unit, arithmetic logic unit, etc. The CPU 110 may be coupled to a memory medium, which may include random access memory (RAM) 114, read only memory (ROM) 116, disk units 120, tape drives 140, and/or optical drives 142, among other types of memory mediums. As shown, the disk units 120, tape drives 140, and optical drives 142 may be coupled to the CPU via input/output (I/O) adapter 118. As shown, these peripheral devices may be coupled to adapter 118 which may be connected via peripheral bus 119 to main bus 112, in one embodiment. The CPU 110 may be configured to execute program instructions (e.g., stored on one or more of the memory mediums above) which implement the system and methods described herein.

Data processing network 144 (coupled to bus 112 via communication adapter 134) may be a wireless, galvanic wired, or optical media network with a star, ring, or other topology. The network 144 may be representative of various types of possible networks, e.g., a local area network (LAN) or a wide area network (WAN), such as the Internet. The systems and methods described herein may be implemented in various embodiments on a plurality of heterogeneous or homogeneous networked computer systems, such as exemplary computer system 101, through one or more networks.

In various embodiments, the CPU 110 may also be coupled through the input/output bus 112 to one or more input/output devices via one or more adapters. For example, the computer system 101 may also include user interface adapter 122 for connecting keyboard 124, mouse 126, and/or other user interface devices such as a touch screen device (not shown) to bus 112. Further included in computer system 101 may be the communication adapter 134 for connecting data processing bus 112 to the data processing network 144 and display adapter 136 for connecting bus 112 to display device 138.

The computer system 101 may include multimedia adapter 150 for connecting bus 112 to microphone 152 and/or loudspeaker system 154. Other types of multimedia output and input devices, such as headphones and stereo speakers (not shown), may be used via analog or digital interfaces with the multimedia adapter 150. In various embodiments, the computer system 101 may also include a track ball, a magnetic or paper tape reader, a tablet, a stylus, a voice recognizer, a handwriting recognizer, a printer, a plotter, a scanner, and any other devices for input and/or output.

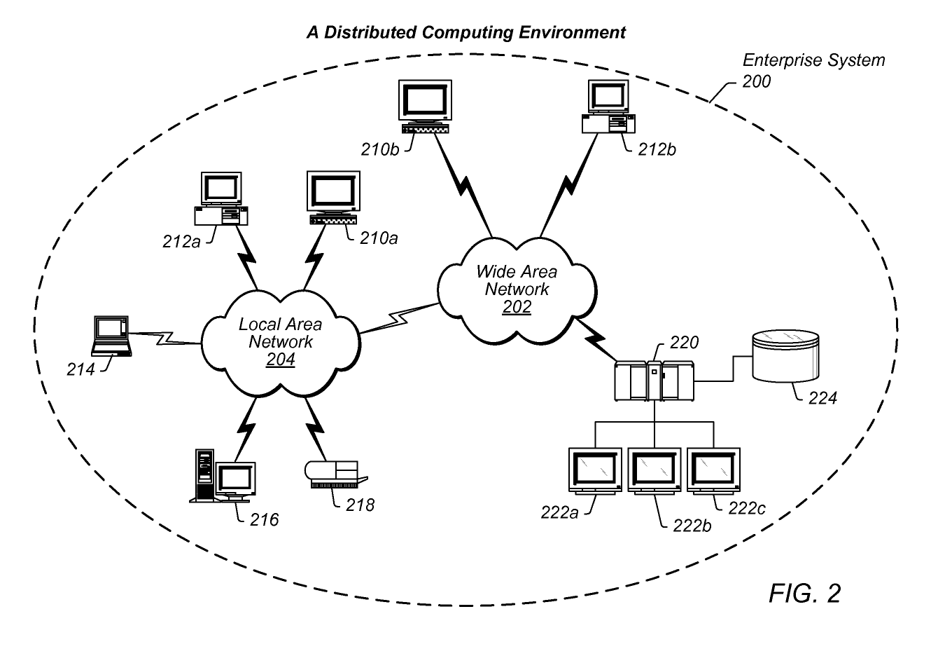

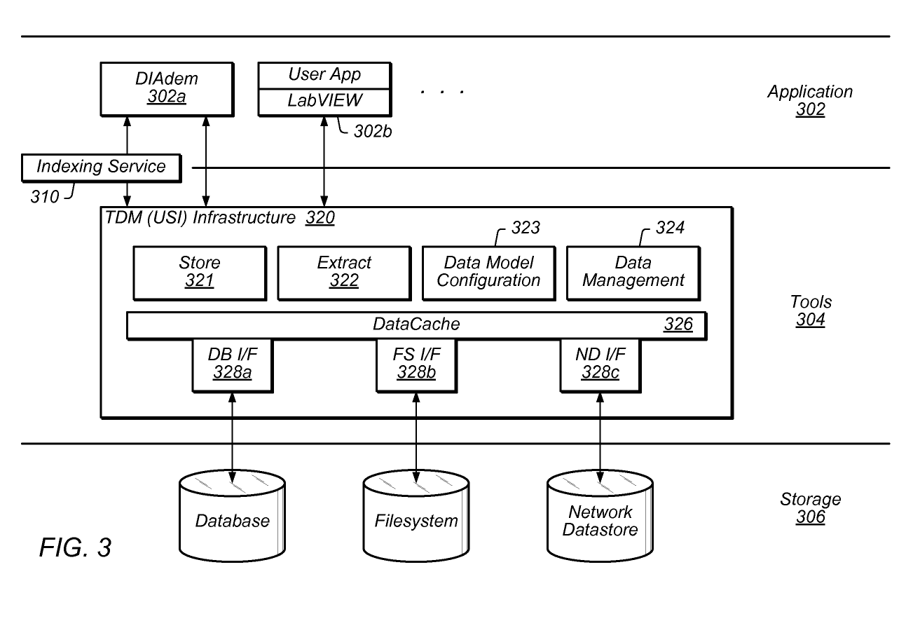

### FIG. 2—Exemplary Distributed Computing Environment

FIG. 2 illustrates an exemplary distributed or enterprise computing environment 200, according to one embodiment. The enterprise 200 may include a plurality of computer systems, such as the computer system 101, which are interconnected through one or more networks. Although one particular embodiment is shown in FIG. 2, the enterprise 200 may comprise a variety of heterogeneous computer systems and networks which are interconnected in a variety of topologies and which run a variety of software applications.

One or more local area networks (LANs) 204 may be included in the enterprise 200. A LAN 204 is a network that spans a relatively small area. Typically, a LAN 204 is confined to a single building or group of buildings. Each node (i.e., an individual computer system or device) of the LAN 204 may include its own CPU with which it executes computer programs, and often each node may be able to access data and devices anywhere on the LAN 204. The LAN 204 thus allows many users to share devices (e.g., printers) as well as data stored on file servers. The LAN 204 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). FIG. 2 illustrates an enterprise 200 including one LAN 204. However, the enterprise 200 may include a plurality of LANs 204 which are coupled to one another through a wide area network (WAN) 202. A WAN 202 is a network that spans a relatively large geographical area.

Each LAN 204 comprises a plurality of interconnected computer systems or at least one computer system and at least one other device. Computer systems and devices which may be interconnected through the LAN 204 may include, for example, one or more of a workstation 210a, a personal computer 212a, a laptop or notebook computer system 214, a server computer system 216, or a network printer 218. The exemplary LAN 204 includes one of each of these computer systems 210a, 212a, 214, and 216 and one printer 218. Each of the computer systems 210a, 212a, 214, and 216 may be an example of computer system 101, as illustrated in FIG. 1. The LAN 204 may be coupled to other computer systems and/or other devices and/or other LANs 204 through a WAN 202.

A mainframe computer system 220 may optionally be coupled to the enterprise 200. As shown in FIG. 2, the mainframe 220 may be coupled to the enterprise 200 through the WAN 202, but alternatively the mainframe 220 may be coupled to the enterprise 200 through a LAN 204. The mainframe 220 may be coupled to a storage device or file server 224 and mainframe terminals 222a, 222b, and 222c. The mainframe terminals 222a, 222b, and 222c may access data stored in the storage device or file server 224 coupled to or included in the mainframe computer system 220.

The enterprise 200 may also comprise one or more computer systems which are connected to the enterprise 200 through the WAN 202. As illustrated, the one or more computer systems may include a workstation 210b and a personal computer 212b. In other words, the enterprise 200 may optionally include one or more computer systems which are not coupled to the enterprise 200 through the LAN 204. For example, the enterprise 200 may include computer systems which are geographically remote. In one embodiment, the Internet may be included in WAN 202.

It is noted that one or more computer systems, as described in FIG. 1 or 2, may couple or connect to a measurement device or instrument that acquires measurement data from a device, UUT, or process. For example, measurement data may be generated by a measurement device (such as a data acquisition device), by an instrument or by an interface to a bus system hosting various devices or instruments. In this manner, the collected measurement data may be ultimately deposited in a data store and made available to any number of applications processing the measurement data in the enterprise system 200.

### FIG. 3—Exemplary Technical Data Management Framework

FIG. 3 illustrates a diagram for an exemplary 3-tier Technical Data Management (TDM) framework, in one embodiment. The TDM framework may include various components for managing the storage and retrieval of technical data (e.g., measurement data) in the enterprise system 200. The organization of the TDM framework in the enterprise system 200, shown in one embodiment in FIG. 3, is based on 3 tiers, or layers of functionality: application layer 302, tools layer 304, and storage layer 306. Each of these layers will be described in detail below. The enterprise system 200 may collectively refer to a collection of applications 302, tools 304, and storage 306, including any required infrastructure and services that are deployed across an enterprise or other organizational structure. In one embodiment, a TDM framework is operable on the enterprise distributed computing environment 200.

The application layer 302 includes the individual applications which may process measurement data in an enterprise system. The application layer 302 may include a plurality of individual application programs which process measurement data. As shown in FIG. 3, in one embodiment, TDM applications from National Instruments Corporation (DIAdem® 302a, and LabVIEW® 302b) may be used to acquire and store measurements, or retrieve measurements from a data store for analysis and visualization. In one example application, an organization performs tests on various devices, e.g., for quality control or R&D purposes, and the results of the tests may include measurement data. In other embodiments, applications in layer 302 may include commercially available software products from various vendors, or customized applications developed within an enterprise or industry.

In one embodiment, individual applications in layer 302 may access the same technical data for various purposes. For example, a first application may use data acquisition hardware to acquire waveform data from the devices, compute RMS and peak information from the data, and store the results. A second application may search for particular data sets that have been stored, perform further analysis on the data sets, and then re-store the data.

The tools layer 304 includes the TDM infrastructure for providing services and interfaces that allow applications in application layer 302 to access resources in storage layer 306. It is noted that tools layer 304 may further include application-specific interface modules, such as indexing service 310, which, in one embodiment, provides access to measurement data by indexing meta-data.

The functionality included in one embodiment of TDM infrastructure 320 may include modules operable to store 321 and extract 322 data from the storage level 306. It is noted that TDM infrastructure may also be referred to as a type of Universal Storage Interface (USI). The store 321 and extract 322 functions may further rely upon a data cache 326 for buffering data going into or coming from storage layer 306.

It is further noted that a data cache 326 may be implemented in various embodiments in different kinds of volatile or non-volatile memory, or any number of combinations thereof. The data cache 326 may provide performance enhancement by caching technical data in a variety of ways. In one embodiment, the data cache 326 stores the most recently accessed (stored or extracted) data, in order to reduce access times for subsequent operations involving the same data. In another embodiment, the data cache 326 may reduce or eliminate the number of accesses to a particular data file, by fetching meta-data and/or some portion of the data file, such that applications 302 are not required to access the data file itself for browsing or querying the file. In other embodiments, the data cache 326 may be coupled to indexing service 310 and store indexed information on measurement data files. Applications, such as the Diadem® 302a and LabVIEW® 302b applications shown in FIG. 3, may utilize any of the storage mechanisms supported by the TDM framework simply by utilizing the provided data cache 326 interface.

The interfaces provided by the TDM framework may allow for the storage and retrieval of data without regard to the storage mechanism (i.e., the type of data store actually accessed in storage layer 306). In other words, the TDM framework may hide differences in the various types of data stores, along with the complexity of the different access mechanisms, from the user/application accessing the data. The same access methods may be used no matter what data store actually stores the data. It is noted that this property of the TDM framework effectively encapsulates the management of various data stores within the TDM framework, and thereby centralizes TDM within the enterprise system 200. Note that the concept of centralization in the presently described methods may be virtual and logical, referring to unified services and management responsibilities; the actual physical location of the data stores, applications, and TDM infrastructure may be distributed across the enterprise, or even be at a remote location.

The TDM infrastructure 320 may further include storage-specific plug-ins, which interface to a given type of storage via the data cache 326. In one embodiment, separate plug-ins for databases 328a, files 328b, and network data 328c may be included in the tools layer 304. In another embodiment, a separate plug-in 328 is installed for each type of individual data store, for example, a given data file format. The types of data stores supported by the TDM framework can be expanded as necessary by adding new plug-ins, corresponding to new types of data stores. Further details regarding such plug-ins are provided in U.S. patent application Ser. No. 11/461,627, which was incorporated in its entirety above.

Additional functions in the tools layer 304 may include data model configuration 323 and data management functions 324. In one embodiment, these functions may be included in the basic TDM infrastructure 320 and may rely upon the data cache and plug-in architecture for accessing data. In other embodiments, these functions may represent administrative tools that are performed as required, for example, according to enterprise policy.

In one embodiment, data management functions 324 may include various functions related to the management of multiple data stores. For example, the data management functions 324 may allow a user or client application to delete entries from a data store or move or copy data store entries. The TDM framework may also support mapping or copying data entries from one data store to another data store. In one embodiment, when different data stores use different data models, a client application may be responsible for mapping the data from one model to another. In another embodiment, automatic conversion between the data models may be supported. The user may need to supply information specifying how the conversion is to be performed. For example, the user may utilize a tool to specify mapping points in the two data models, provided by TDM infrastructure 320.

In one embodiment, the TDM framework may also support automatic synchronization/replication between multiple copies of the same data store. For example, when a change to one of the copies is made, the other copies may be automatically updated to reflect the change. The synchronization/replication process may be bi-directional. Each data store may reflect the complete and most up to date status after the synchronization/replication. Updates may be performed with each change or at regular intervals.

The TDM framework may utilize data models to support the concept of self-describing measurement data. A data model may define a structure of data items, their attributes, and relationships between different data items. In one embodiment, the data model configuration 323 and data management 324 functions may be used to configure and manage information relating to a data model, such as meta-data.

Information describing the data model is called meta-data. The meta-data in the data model give meaning to the actual stored data by specifying what the data represents. It is often useful to explicitly state and store the data model used by a particular application, especially in larger applications or where the data is used by multiple applications. An application or user unfamiliar with the data can apply the meta-data to properly interpret the data.

In one embodiment, the TDM framework may enable users to define and use their own data models using meta-data. Defining a data model by storing meta-data with the measurement data may impart a self-describing quality to a particular data store. For example, if channel or trace data can be recognized as an entity that includes bulk waveform data, applications that use the channel or trace data can offer adapted methods to deal with this waveform data, e.g., to display it in a diagram. The meta-data may also make it easier to keep measurement data consistent, by providing examples and historical records of previously acquired measurement data. In one example, the meta-data in an existing data store may be reused as a template, or may be adapted for storing a similar or related measurement.

The term data model architecture refers to the structure of a valid data model, whereas meta-data represent the implementation on a particular data model. The data model architecture may define the pieces of a data model, and how the different pieces can be linked or joined into a data model. Note that knowledge of the data model architecture is not required for accessing (e.g., indexing, browsing, querying) measurement data using the methods described herein; the TDM framework, including meta-data, provides the necessary information for accessing measurement data. In one embodiment, instructions relating to the interpretation of a particular data model architecture are implemented in a plug-in, which directly accesses a measurement data file to retrieve meta-data and measurement data stored according to that data model.

In various embodiments, the data models utilized by the TDM framework may be implemented according to any of various data model architectures. According to one embodiment, the meta-data includes two parts, the base model and the application model, which is derived form the base model. The base model may describe the basic elements of a data source or data store. It may also include elements to describe measurement data, administrative information, units, dimensions, and provisions for any application-specific data. The application model may be derived from the base model and may describe the specific elements of the data model for a particular application. The base model serves as a general guideline for how application models in a group of applications should be setup. However, the application model defines the data model for each individual application.

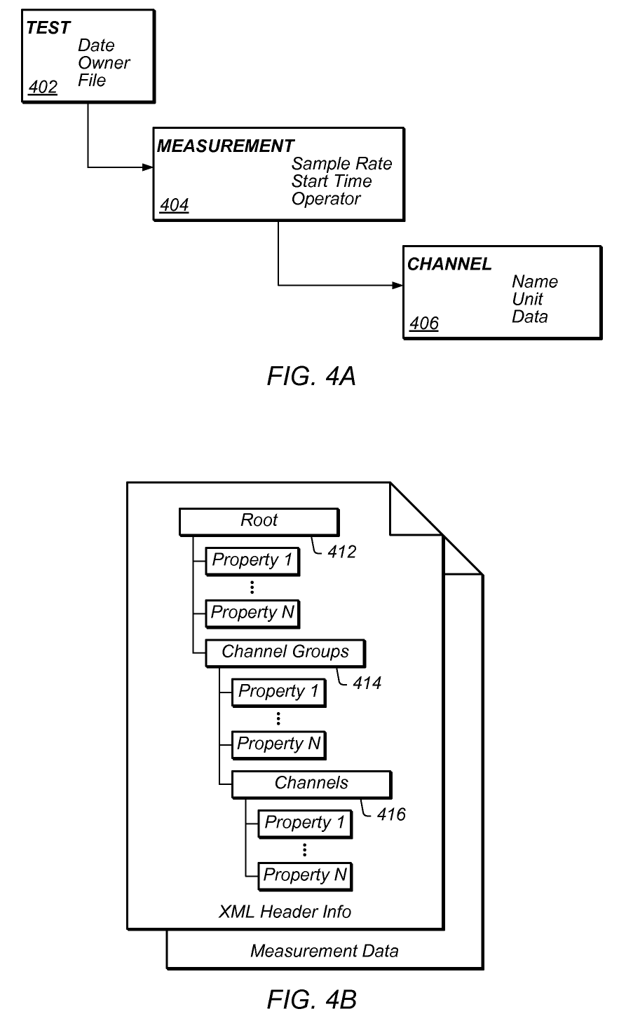

In other embodiments involving measurement data, the data model may represent a hierarchical data model, for example, a TDM data model. In one embodiment presented in detail below, a TDM data model comprises a 3-level hierarchy of meta-data, including: a file/root level; a group/type/setup level; and a signal/channel/trace level. Each of these levels in the hierarchical data model may be associated with its own kind of meta-data for describing that level, as described with the following examples, which correspond to the illustration in FIGS. 4A and 4B. FIG. 4A shows a specific example of a more general hierarchical TDM data model illustrated in one embodiment in FIG. 4B. In one exemplary embodiment, a TDM data model involves splitting the measurement information (i.e., measurement data) and attribute information (i.e., meta-data) into separate files, one that contains all the measurement data in a binary form and an XML header to manage the structure and attributes. This combination of binary and XML may provide significant advantages for fast, portable, flexible, and search ready TDM data files. In various other embodiments (not shown), a hierarchical model of data using different numbers of levels and organizations may be used with the methods described herein.

In some embodiments, the highest level 412 in the hierarchical model is the file/root level, which may include meta-data for one or more of the following aspects related to the storage of a measurement data file:
timestamp information for the measurement data
owner of the measurement data
name of the file/root
type of the file/root
format of the file/root
path/location of the file/root.
   One example of the file/root level is shown by the TEST field 402, which includes the data, owner and file information.

In some embodiments, the middle level 414 in hierarchical model is the group/type/setup level, which may include meta-data for one or more of the following aspects related to the organization of the data in a measurement data file:
type of measurement of the group/type/setup
description of the type of measurement
operator of the group/type/setup
recommended type of analysis/post-processing for the group/type/setup
reference to another document describing the measurement setup/channel list in the group/type/setup
measurement setup/channel list in the group/type/setup
sample rate for group/type/setup.
   One example of the group/type/setup level is shown by the MEASUREMENT field 404, which includes the sample rate, start time and operator of the measurements in a setup.

In some embodiments, the lowest level 416 in hierarchical model is the signal/channel/trace level, which may include meta-data for one or more of the following aspects related to an individual channel or signal of data in a measurement data file:
name of the signal/channel/trace
engineering unit for the signal/channel/trace
description of the engineering unit
description of the signal/channel/trace
unique ID for the signal/channel/trace
unique ID for the sensor/transducer measuring the signal/channel/trace
an image of the signal/channel/trace
a set of data points included in the signal/channel/trace.
   One example of the signal/channel/trace level is shown by the CHANNEL field 406, which includes the name, unit and data for one or more channels of measurement data.

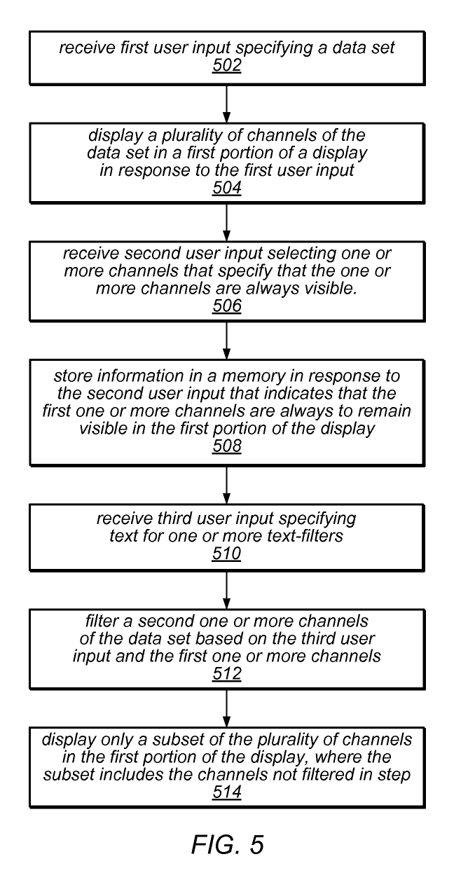

### FIG. 5—Exemplary Method for Selecting Channels of a Data Set

The TDM framework may also include various utilities to search, view, or analyze technical data, including for example various embodiments of the method described in FIG. 5. These utilities may utilize the underlying interfaces provided by the TDM framework. The TDM framework may also provide a set of user interface components.

FIG. 5 illustrates one embodiment of a method for selecting channels of a data set to always be visible in a display. The method shown in FIG. 5 may be used in conjunction with any of the computers systems or devices shown in the above Figures, among other devices. In various embodiments, some of the method elements shown may be performed concurrently, in a different order than shown, or may be omitted. Additional method elements may also be performed as desired. As shown, this method may operate as follows.

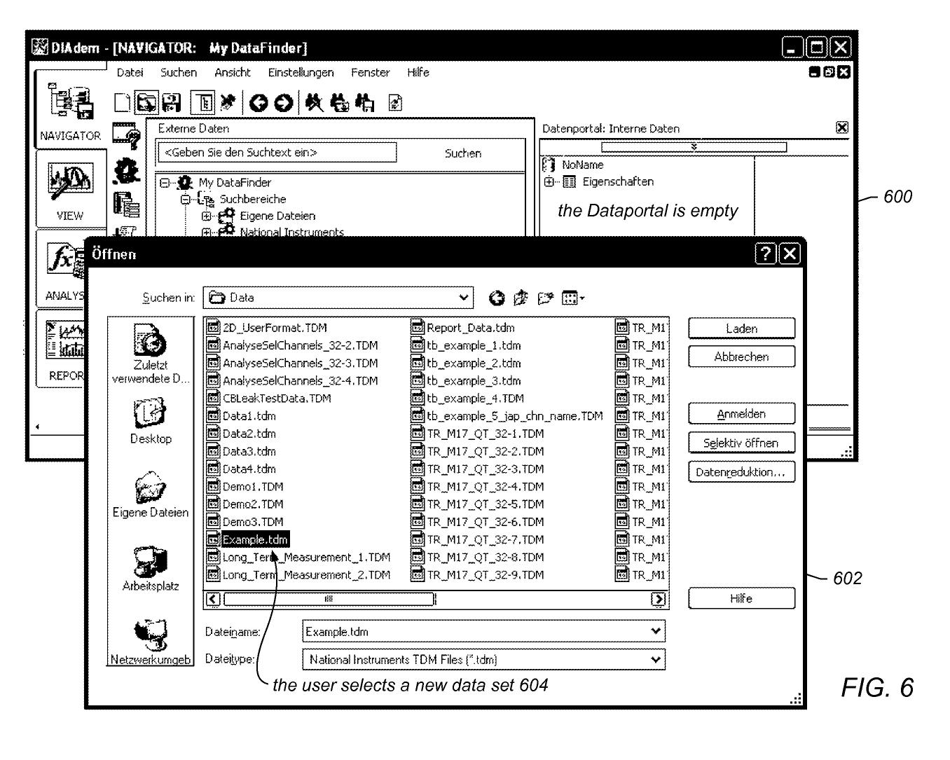

In 502, first user input specifying a data set may be received. As indicated above, the data set may include measurement data, e.g., data acquired by a test and measurement application, e.g., via test and measurement hardware, such as data acquisition (DAQ) hardware or other hardware. The data set may take any number of forms, for example a TDM data model, such as those described above and including the embodiment illustrated in FIGS. 4A and 4B, although other forms are also envisioned. As exemplified by FIG. 6, the first user input 604, which specifies the data set, may be provided via browser 602 of software application 600. As indicated above, the software application 600 may be a TDM software application, such as DIAdem® from National Instruments Corporation. However, other embodiments are also envisioned; for example, it may be possible to receive the first user input specifying the data set 604 at a command prompt, e.g. of the software application 600, at a DOS prompt, etc. Additionally, other graphical methods of selecting or otherwise specifying data sets are envisioned.

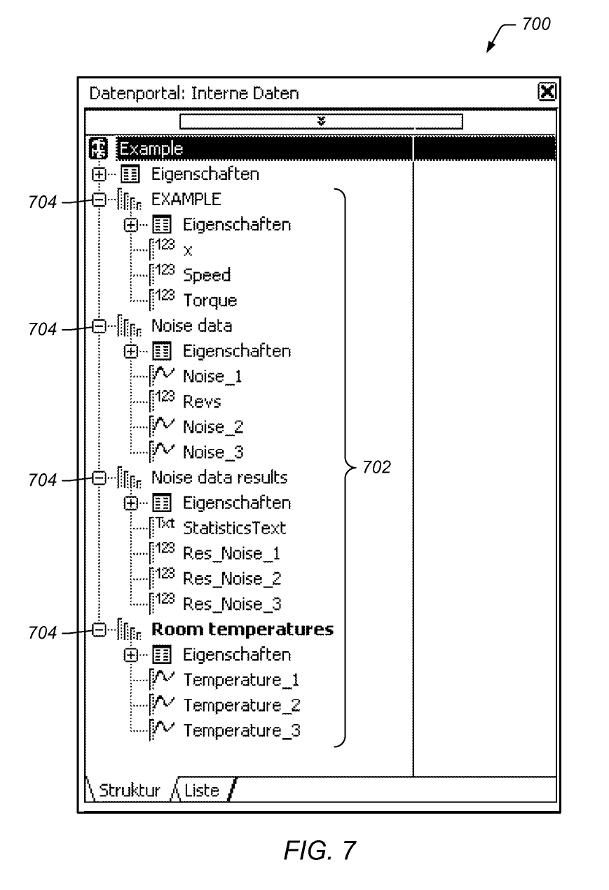

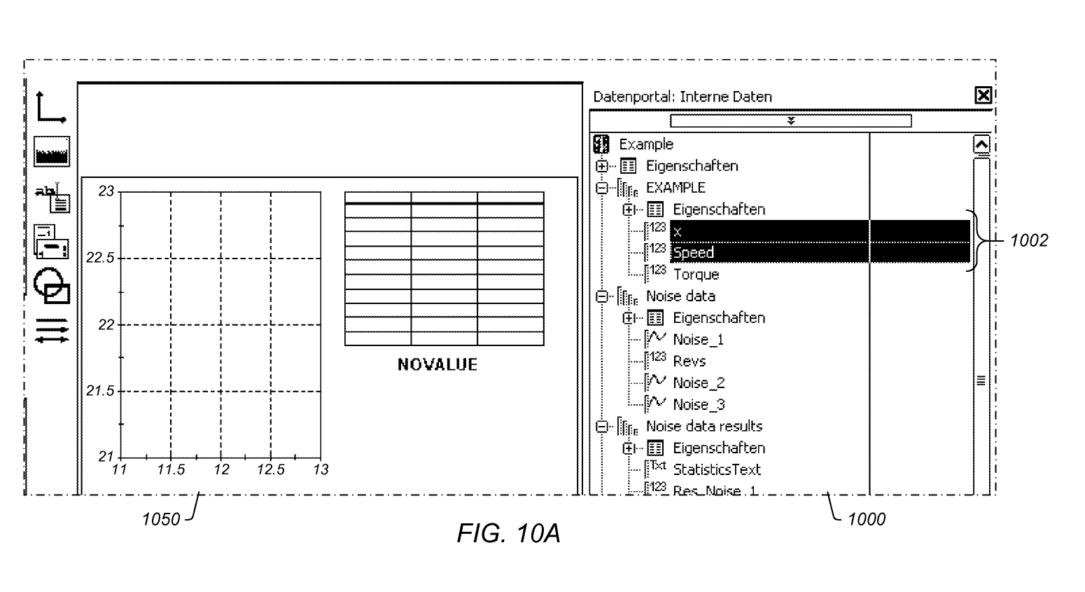

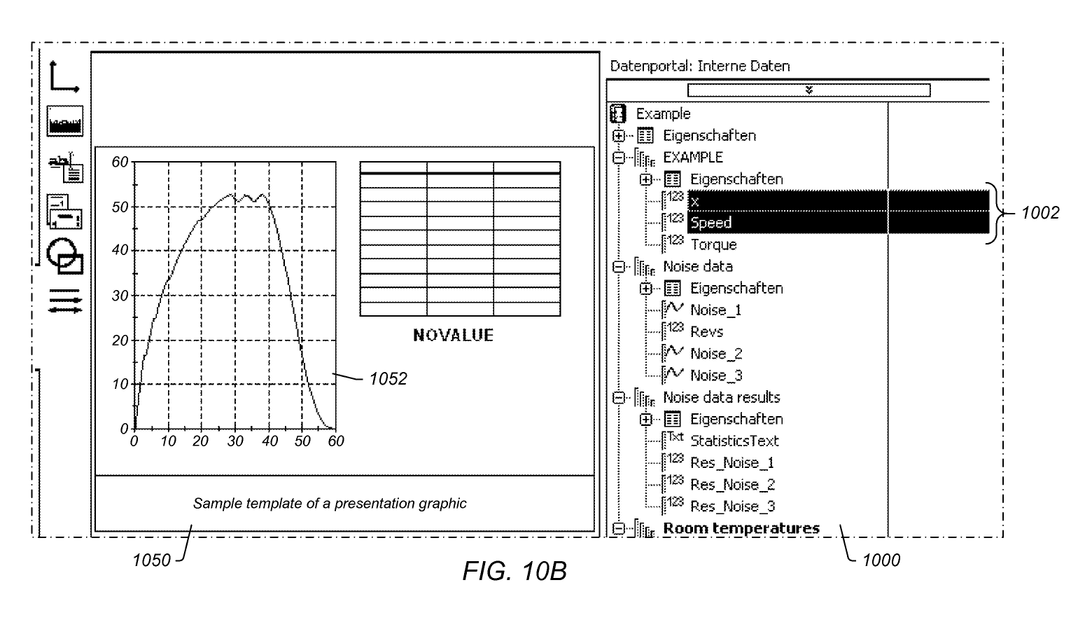

In 504, a plurality of channels of the data set may be displayed in a first portion of a display in response to the first user input. FIG. 7 illustrates one embodiment of the first portion of the display which shows the plurality of channels of the data set. As shown in FIGS. 10A and 10B (described in more detail below), the first portion of the display may be displayed with a second portion of the display. Each channel of the plurality of channels 702 may correspond to a particular data subset of the data set. Additionally, each channel may be labeled and/or contain metadata describing the measurement data and/or other data included in the channel. The plurality of channels 702 may in some embodiments be a large number of channels, e.g. 1,000, 10,000, or more. Alternatively the plurality of channels 702 may be a smaller number, or any plurality of channels. In some embodiments, each channel may include only data, or alternatively, may also contain other information such as labels and/or metadata. Furthermore, in some embodiments, the channels may be divided into groups 704 of channels, which may also be visible in the first portion of the display 700.

In 506, second user input selecting a first one or more channels and specifying that the first one or more channels are always visible may be received. In some embodiments, the second user input specifying that the first one or more channels are always visible in the first portion of the display 700 may include selecting one or more groups of channels and specifying that the one or more groups of channels are always visible in the first portion of the display. Thus, the first one or more channels may be specified by selecting the one or more groups of channels. In some embodiments, the second user input may select one or more groups of channels and one or more individual channels.

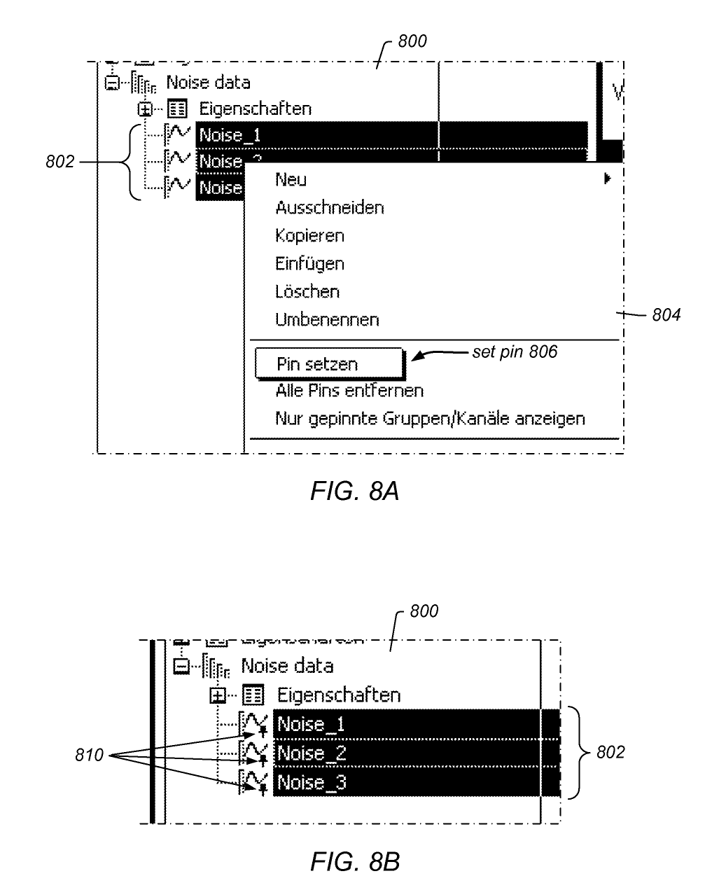

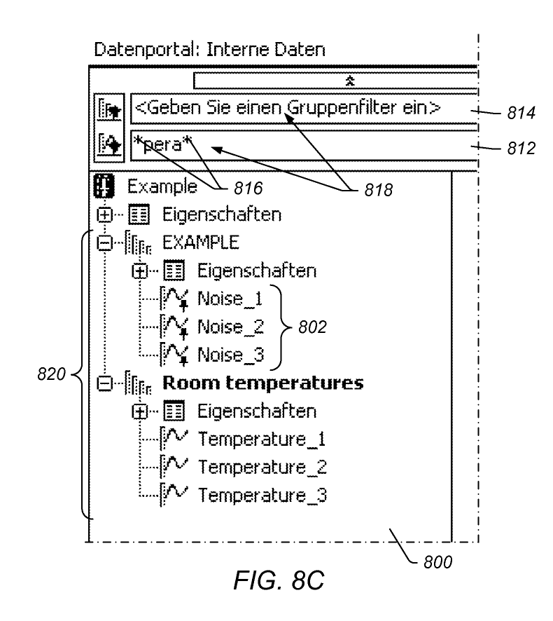

FIG. 8A illustrates one embodiment of the selection of 506. As shown, the second user input selecting the first one or more channels 802 may include selecting the first one or more channels (e.g., by clicking on the channels), entering a context-menu 804 (e.g., by right-clicking), and selecting a menu item 806 that specifies that the first one or more channels 802 are always visible in the first portion of the display 800 (“set pin”). Other embodiments are also envisioned. For example, it may be possible to select and specify that the one or more channels 802 are always visible in the first portion of the display 800 from a file-menu, or from a command prompt, among other possible embodiments.

In 508, information may be stored in a memory in response to the second user input. The information may specify or otherwise indicate that the first one or more channels are always to remain visible in the first portion of the display. In some embodiments, this may be denoted visually in the first portion of the display, for example with one or more graphical icons, which may be associated with each of the first one or more channels in the first portion of the display.

One possible embodiment of this graphical indication is illustrated in FIG. 8B. As shown, there is a graphical icon 810 (e.g., represented as a thumbtack) in the first portion of the display 800 next to each of the selected first one or more channels 802. Other embodiments are also envisioned, which may include different shapes, positions, colors, and/or number of graphical icons displayed. Alternate embodiments, for example in which there are no graphical icons displayed, or in which there are no graphical icons but another form of visual indication exists, e.g. bold or italic channel name text, colored channels names, etc., are also envisioned.

In 510, third user input specifying text for one or more text-filters may be received. As in the embodiment exemplified by FIG. 8C, there may be a text-filter for channels 812 and a text-filter for groups of channels 814. Alternatively, in other embodiments there may be a single text-filter or more than two text-filters. The one or more text-filters may be simple text-filters or may have advanced filtering capabilities, such as including Booleans such as “AND”, “OR”, etc, and/or wildcards, such as the asterisks 816 exemplified in FIG. 8C. In some embodiments, the user input to the one or more filters may be received in a text-field 818 in the first portion of the display 800 as exemplified by FIG. 8C. In other embodiments, the third user input may be received in another location on the display, or may include intermediate steps such as a dialog box being opened before the third user input is received. Other possible embodiments for receiving the third user input are also envisioned. In addition, in some embodiments, forms of filtering that use characteristics in addition to or instead of text, for example characteristics of the data itself, such as root mean squares or peak values among other examples, may also be possible.

In 512, a second one or more channels of the plurality of channels of the data set may be filtered based on the third user input specifying text for one or more text-filters 812, 814. In alternate embodiments such as those utilizing one or more non-text filters, e.g. filters based on characteristics of the data, or one or more non-text filters in combination with one or more text-filters, the third user input may not be limited to specified text, but may include other forms of input in addition to or in place of the specified text.

In 514, only a subset of the plurality of channels may be displayed in the first portion of the display. The subset may include the channels not filtered in step 512 as well as the first one or more channels. The subset may have been determined using both the second user input selecting the first one or more channels specifying that the first one or more channels always be visible in the first portion of the display and the third user input specifying text for one or more text-filters.

FIG. 8C is an exemplary illustration of one embodiment of this step. In the embodiment shown, the subset 820 includes the channels including the text “pera” (with any number of characters before or after, as specified by the *'s), e.g. Temperature_1, Temperature_2, etc., as specified by an exemplary third user input in the one or more text-filters 812, 814. In the embodiment shown, the subset 820 also includes the first one or more channels 802 specified by a previous exemplary second user input to always be visible in the first portion of the display. Note that without the second user input specifying the first one or more channels 802, the channels 802 would not be displayed based on the query (third user input) “*pera*” since the channels 802 do not include this text. Thus, the first one or more channels are displayed regardless of the query specified in 812 or 814 based on the second user input.

Note that the specific order of the above steps are exemplary only. For example, in some embodiments, steps 506 and 508 may be performed after steps 510-514. In these embodiments, input for the one or more filters may be received before input specifying the first one or more channels to always be visible in the first portion of the display, in which case the subset may include only those channels that meet the conditions of the one or more filters.

The steps shown in the flowchart of FIG. 5 exemplify one set of embodiments of the method described herein; however, as indicated above, it should be noted that other possible embodiments may include performing the steps of FIG. 5 in a different order than that shown. Some embodiments may also include method steps in addition to or in replacement of those described by FIG. 5, or may not require that all the steps shown in FIG. 5 be performed. Some embodiments of possible additional or replacement steps are described below.

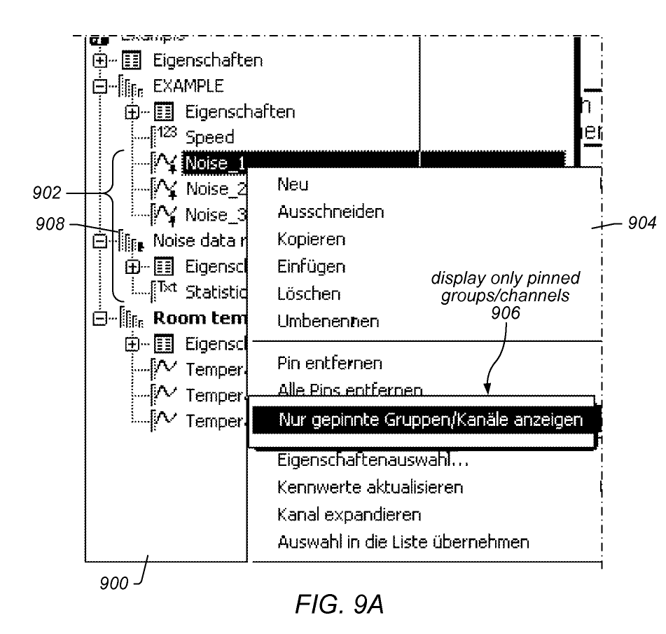

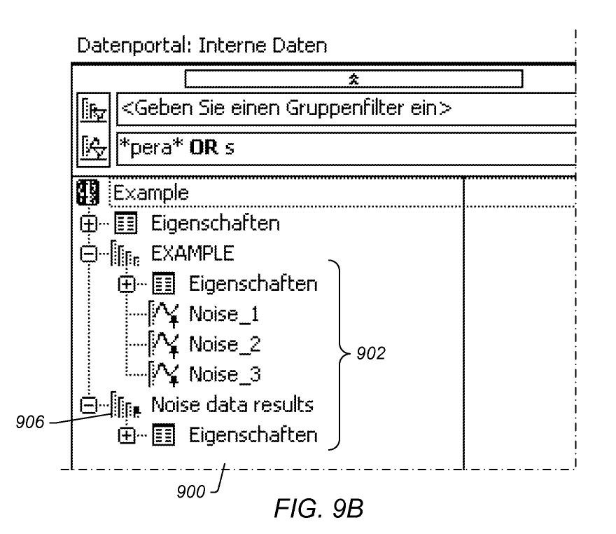

In some embodiments, after the user input selecting the first one or more channels and specifying that they always be visible in the first portion of the display is received, it may be possible to receive an additional user input specifying that only the first one or more channels by displayed. As exemplified by the embodiment shown in FIG. 9A, the additional user input may be received via a menu item 906 in a context menu 904. However, in other embodiments, the additional user input may be received by other means. After receiving the additional user input, only the first one or more channels 902 may be displayed in the first portion of the display 900, as shown in FIG. 9B. As shown in this embodiment and mentioned above, the first one or more channels 902 may include one or more groups of channels 908. However, in other embodiments the first one or more channels may include only individual channels. In some embodiments, it may also be possible that further additional user input be received. This further user input may specify that the first one or more channels may no longer be the only channels displayed.

In some embodiments, it may be possible to display at least a portion of the data set in a second portion of the display. Like the other steps described herein, it may be possible to perform this step in combination with any of the other steps in a variety of orders, in various embodiments. In some embodiments, user input selecting one or more channels and specifying that the data corresponding to the one or more channels be displayed in a second portion of the display may be received. The selected one or more channels may include any of the plurality of channels of the data set. An exemplary illustration of one possible embodiment is shown in FIG. 10A. As in the embodiment shown, it may be possible to receive this user input by the user “dragging and dropping” the desired channels 1002 from the first portion of the display 1000 into the second portion of the display 1050. Alternatively, the user may simply select the desired channels 1002. Other embodiments may include other means of receiving this user input, for example, menu items in context- or file-menus, or text commands entered into command prompts, among other possibilities.

After receiving this user input, the data corresponding to the selected one or more channels may be displayed in the second portion of the display, exemplified as in one embodiment by FIG. 10B. The data displayed may be in the form of one or more graphs 1052, as shown in FIG. 10B, or as one or more charts, lists or tables, and/or as any combination of one or more graphs, charts, lists, and tables, in various embodiments. Displaying the data in the second portion of the display 1050 in additional or other forms is also envisioned. It should also be noted that while in the embodiment exemplified by FIG. 10B, the first portion of the display 1000 is on the right and the second portion of the display 1050 is on the left, other embodiments, such as the reverse of that or indeed any number of possible layouts, are envisioned, including top and bottom, divided diagonally, etc. In some embodiments, it may also be possible that the display may incorporate two or more physically distinct displays, e.g. multiple computer monitors, such that the first portion of the display may be physically distinct from the second portion of the display, although as described herein they may logically represent a single coherent display.

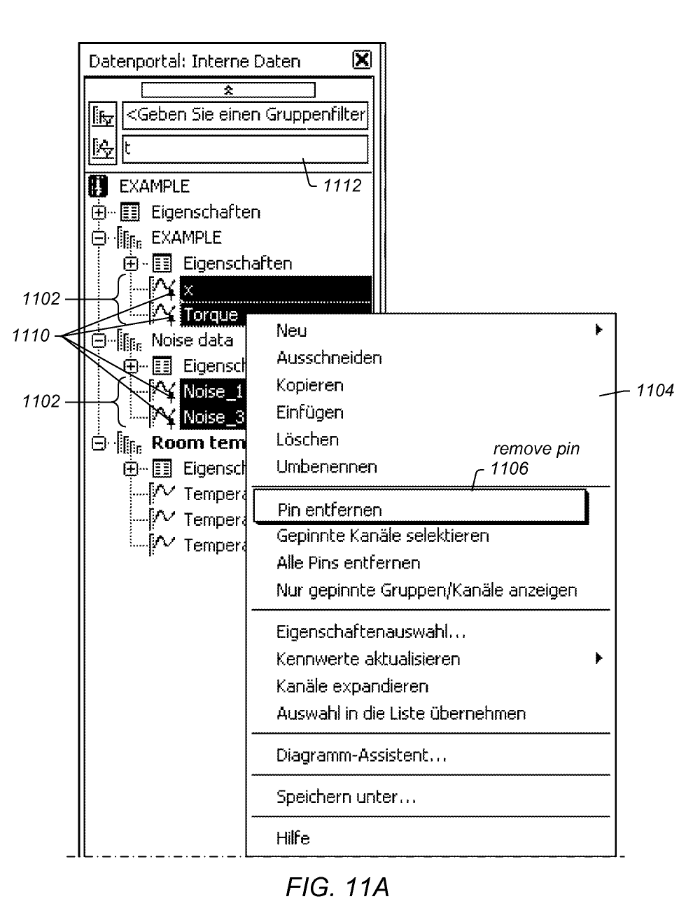

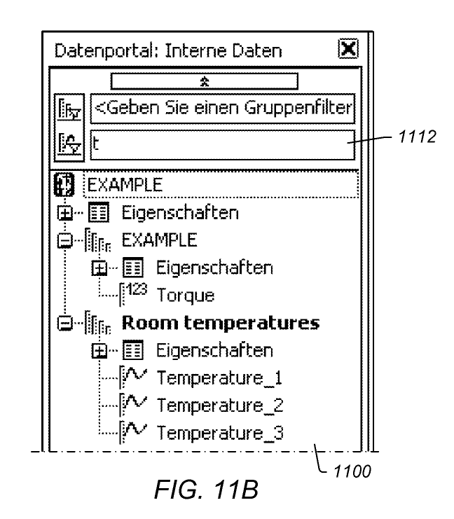

In some embodiments, user input selecting one or more channels and specifying that the one or more channels are no longer always visible in the first portion of the display may be received. An example of one such embodiment is illustrated in FIG. 11A. In this embodiment, the selected one or more channels 1102 have been previously selected by the second user input specifying the first one or more channels to always be visible in the first portion of the display (as in the embodiment shown is visually indicated by a graphical icon 1110). The selected one or more channels 1102 will no longer always be visible, after this user input is received, in this embodiment. This user input may be received via a menu item 1106 in a context menu 1104. Alternate embodiments may include other means of receiving this user input. In this particular exemplary embodiment, there is a text-filter 1112 active, whose conditions some of the selected channels do not meet. In this particular embodiment, the channels “x”, “Noise_1”, and “Noise 3” do not meet the conditions of the active filter 1112 and are thus being shown only as a result of the second user input specifying that they always be visible, while the channel “Torque” meets the conditions of the active filter (channel name starts with “t”, in this particular example) and would still be visible even without the second user input.

FIG. 11B is an exemplary screenshot of the embodiment just described, after the user input specifying that the selected one or more channels 1102 are no longer always visible in the first portion of the display 1100 is received. After this user input is received, the selected one or more channels are no longer always visible, and may be filtered by the active filter 1112 shown in this particular embodiment. As a result, in this particular embodiment, while the channel “Torque” remains visible in the first portion of the display 1100, the channels “x”, “Noise_1”, and “Noise_3” shown in FIG. 11A are no longer visible. It should be noted that while the embodiment just described and illustrated in FIGS. 11A and 11B has been described in considerable detail, many other similar embodiments may also be possible. For example, in other embodiments, there may not be a text-filter active when this user input specifying that the selected one or more channels are no longer always visible is received, or there may be multiple filters active. Other variations and embodiments are also envisioned.

Although many of the steps and elements of the method described above are given in sequential order, it is not intended that the steps be limited to the order presented. Instead, any number of possible variations of the given order are envisioned, including but not limited to repeating certain steps, either performed sequentially or with other steps performed between iterations, omitting certain steps, and changing the order of certain steps.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-accessible memory medium comprising program instructions, wherein the program instructions are executable to:
receive first user input specifying a data set;
display a plurality of channels of the data set in a first portion of a display in response to the first user input; and
receive second user input selecting a first one or more channels of the data set in the first portion of the display, wherein the second user input selecting the first one or more channels of the data set specifies that the first one or more channels are always visible in the first portion of the display;
wherein, in response to the second user input, the first one or more channels remain visible in the first portion of the display regardless of any filtering performed on the plurality of channels.

2. The memory medium of claim 1, wherein after being selected, the program instructions are further executable to display at least one graphical icon in the first portion of the display associated with the first one or more channels, wherein the at least one graphical icon visually indicates that the first one or more channels are always visible in the first portion of the display.

3. The memory medium of claim 1, wherein the program instructions are further executable to:
receive third user input specifying text for one or more text-filters; and
filter a second one or more channels of the data based on the third user input, wherein after filtering, the second one or more channels are no longer visible in the first portion of the display, and wherein the first one or more channels remain visible in the first portion of the display regardless of the one or more text-filters.

4. The memory medium of claim 1, wherein the program instructions are further executable to:
receive third user input selecting a second one or more channels, wherein the third user input selecting the second one or more channels specifies that the second one or more channels are no longer always visible in the first portion of the display.

5. The memory medium of claim 1, wherein the program instructions are further executable to:
receive third user input specifying that only the first one or more channels are visible in the first portion of the display; and
display only the first one or more channels in the first portion of the display based on the third user input.

6. The memory medium of claim 1,
wherein the plurality of channels of the data set are divided into groups, wherein the groups are visible in the first portion of the display; and
wherein the second user input selecting the first one or more channels of the data set comprises selecting one or more groups.

7. The memory medium of claim 1, wherein the program instructions are further executable to:
display at least a portion of the data set in a second portion of the display.

8. The memory medium of claim 1, wherein the program instructions are further executable to:
receive third user input selecting a second one or more channels, wherein the third user input selecting the second one or more channels specifies that data corresponding to the second one or more channels be displayed in a second portion of the display; and
display the data corresponding to the second one or more channels in a second portion of the display in response to the third user input.

9. The memory medium of claim 1, wherein the data set comprises measurement data.

10. The memory medium of claim 1, wherein the first portion of the display comprises a hierarchical tree-structure.

11. A computer-implemented method, comprising:
receiving first user input specifying a data set;
displaying a plurality of channels of the data set in a first portion of a display in response to the first user input;
receiving second user input selecting a first one or more channels of the data set in the first portion of the display, wherein the second user input selecting the first one or more channels of the data set specifies that the first one or more channels are always visible in the first portion of the display;
storing information in a memory in response to the second user input, wherein the information indicates that the first one or more channels are always to remain visible in the first portion of the display regardless of any filtering performed on the plurality of channels.

12. The method of claim 11, further comprising:
receiving third user input specifying text for one or more text-filters; and
filtering a second one or more channels of the data based on the third user input, wherein after filtering, the second one or more channels are no longer visible in the first portion of the display, and wherein the first one or more channels remain visible in the first portion of the display regardless of the one or more text-filters.

13. The method of claim 11, further comprising:
receiving third user input selecting a second one or more channels, wherein the third user input selecting the second one or more channels specifies that the second one or more channels are no longer always visible in the first portion of the display.

14. The method of claim 11, further comprising:
receiving third user input specifying that only the first one or more channels are visible in the first portion of the display; and
displaying only the first one or more channels in the first portion of the display based on the third user input.

15. The method of claim 11,
wherein the plurality of channels of the data set are divided into groups, wherein the groups are visible in the first portion of the display; and
wherein the second user input selecting the first one or more channels of the data set comprises selecting one or more groups.

16. The method of claim 11, further comprising:
displaying at least a portion of the data set in a second portion of the display;

17. The method of claim 11, further comprising:
receiving third user input selecting a second one or more channels, wherein the third user input selecting the second one or more channels specifies that data corresponding to the second one or more channels be displayed in a second portion of the display; and
displaying the data corresponding to the second one or more channels in a second portion of the display in response to the third user input.

18. The method of claim 11, wherein the data set comprises measurement data.

19. A system, comprising:
a processor;
a display coupled to the processor; and
a memory medium coupled to the processor, wherein the memory medium stores a data set, and wherein the memory medium stores program instructions executable by the processor to:
receive first user input specifying a data set;
display a plurality of channels of the data set in a first portion of a display in response to the first user input; and
receive second user input selecting a first one or more channels of the data set in the first portion of the display, wherein the second user input selecting the first one or more channels of the data set specifies that the first one or more channels are always visible in the first portion of the display;
storing information in a memory in response to the second user input, wherein the information indicates that the first one or more channels are always to remain visible in the first portion of the display regardless of any filtering performed on the plurality of channels.

20. The system of claim 19, wherein said program instructions are further executable by the processor to:
receive third user input specifying text for one or more text-filters; and
filter a second one or more channels of the data based on the third user input, wherein after filtering, the second one or more channels are no longer visible in the first portion of the display, and wherein the first one or more channels remain visible in the first portion of the display regardless of the one or more text-filters.

21. The system of claim 19, wherein said program instructions are further executable by the processor to:
receive third user input selecting a second one or more channels, wherein the third user input selecting the second one or more channels specifies that the second one or more channels are no longer always visible in the first portion of the display.
